(19) United States
(12) Patent Application Publication
(10) Pub. No.: US 2009/0193400 A1
(43) Pub. Date: Jul. 30, 2009

(54) Interprocedural register allocation for global variables

(76) Inventors: Ivan Baev, Cupertino, CA (US); Kerchival F. Holt, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/012,050

(22) Filed: Jan. 30, 2008

(51) Int. Cl. G06F 9/45

(52) U.S. Cl. 717/140

(57) ABSTRACT

A method of compiling a computer program with interprocedural register allocation for global variables. The method of compiling includes a front-end phase, an interprocedural analysis phase, and a back-end phase. The interprocedural analysis phase receives intermediate representations from the front-end phase, processes the intermediate representations together to compute interprocedural information, and outputs optimized intermediate representations. During the interprocedural analysis phase, a set of eligible global variables are selected for promotion, wherein promotion of the selected eligible global variables comprises replacing memory references to said variables with references to global registers assigned to said variables. Other embodiments, aspects and features are also disclosed.

### BACKGROUND OF THE INVENTION

1. Field of the Invention

The present invention relates generally to computer software and more particularly to compilers for computer software.

2. Description of the Background Art

At present, there are two common steps involved in constructing an application program that will run on a computer. The first step is the compilation phase that accomplishes a translation of the source code to a set of object files written in machine language. The second step is the link phase that combines the set of object files into an executable object code file.

Today, most modern programming languages support the concept of separate compilation, wherein a single computer source code listing is broken up into separate modules that can be fed individually to the language translator that generates the machine code. This separation action allows better management of the program's source code and allows faster compilation of the program.

The use of modules during the compilation process enables substantial savings in required memory in the computer on which the compiler executes. However, such use limits the level of application performance achieved by the compiler. For instance, optimization actions that are taken by a compiler are generally restricted to procedures contained within a module, with the module barrier limiting the access of the compiler to other procedures in other modules.

The modular handling of routines by the compiler creates a barrier across which information, which could be of use to the compiler, is invisible. It has been recognized in the prior art that making cross-modular information available during the compilation action will improve application performance. Thus, a compiler that can see across modular barriers (a cross-module optimizing compiler) can achieve significant benefits of inter-procedural optimization and achieve noticeable gains in performance of the resulting application.

### BRIEF DESCRIPTION OF THE DRAWINGS

FIG. 1 is a schematic diagram illustrating an apparatus including a interprocedural optimizer in accordance with an embodiment of the invention.

FIG. 2A depicts a method performed to generate a summary for each procedure in accordance with an embodiment of the invention.

FIG. 2B is a flow chart depicting a method of updating reference counts after each inlining transformation in accordance with an embodiment of the invention.

FIG. 3 is a flow chart depicting a method in which an algorithm for efficient interprocedural register allocation is performed in accordance with an embodiment of the invention.

FIG. 4 is a flow chart depicting a fast algorithm for efficient interprocedural register allocation of global variables in accordance with an embodiment of the invention.

FIG. 5 is a flow chart depicting an interference graph based algorithm for efficient interprocedural register allocation of global variables in accordance with another embodiment of the invention.

FIG. 6A is a call graph showing procedures of an example software application being compiled and call sites between those procedures.

FIG. 6B shows color webs laid over the call graph of the example software application.

FIG. 6C depicts an interference graph for the example software application.

FIG. 7 is a schematic diagram depicting an example computer apparatus which may be configured to perform the methods in accordance with an embodiment of the invention.

### DETAILED DESCRIPTION

The present application discloses an effective solution to problems relating to high register pressure. For a processor with a register stack, high register pressure may manifest in at least two ways.

First, there may be explicit spills from the registers to memory and explicit fills from memory to registers. These explicit spills and fills may be referred to as explicit memory references. Second, there may be implicit spills and fills generated by the register stack engine (RSE). Both explicit memory references and implicit RSE spills are typically high for applications with a large number of global variables and references to global variables. The present application discloses a solution to both these problems.

An RSE is generally implemented on a circular array of physical registers. When a register stack frame is allocated for a procedure, and the number of available registers in the array is smaller than the size of the frame, then the RSE spills from data from registers to memory to make room for the new register stack frame. Similarly, when returning from a procedure call it may be necessary for the RSE to restore the caller's register stack frame from memory. For a number of applications, these implicit spills/fills account for a non-trivial component of runtime as high as 8% in the case of the SPEC benchmark tests 186.crafty and 177.mesa. See I. Baev, R. Hank, and D. Gross, “Prematerialization: reducing register pressure for free,” Proceedings of PACT '06 Conference, 2006, hereinafter “the Baev reference”.

The increasing gap between the times needed to access a memory location versus the times needed to access a register poses a performance problem for applications with a large number of global variables. In absence of interprocedural information, loads must be inserted in the prologue and after every call in procedures referencing global variables, and similarly stores must be inserted in the epilogue and before every call.

The latency related to these loads and stores often cannot be accommodated without an increase in the schedule length. In addition, global memory instructions are preceded by instructions to calculate their addresses. On a processor with a register stack, memory addresses, commonly based on offsets from other registers, are usually held in stacked registers which may further increase the amount of RSE spills.

The number of memory references to global variables may be reduced by global redundancy optimizations. However, this approach, exemplified by partial redundancy elimination and global code motion, is restricted to within a single procedure. Furthermore, global redundancy optimizations cannot eliminate memory references to global variables before and after a call.

The number of memory references to global variables may also be reduced by interprocedural register allocation schemes. This approach has been previously implemented by performing interprocedural register allocation at link time (see D. Wall, “Global register allocation at link-time, “Proceedings of the SIGPLAN'86 Symposium on Compiler Construction, 1986, hereinafter “the Wall reference”), or by using a two-pass compilation method (V. Santhanam and D. Odnert, “Register allocation across procedure and module boundaries,” Proceedings of PLDI '90 Conference, 1990, hereinafter “the Santhanam reference”).

In the Wall reference, the allocator uses estimated access frequencies to decide what local and global variables should be allocated to registers, and rewrites the code at link time to reflect the promotion of selected variables to registers. However, code rewriting at link-time for processors with a register stack would be very difficult because local variables and compiler temporaries in a procedure are assigned consecutive locations on the procedure's register stack frame. This prevents the Wall reference's approach from being very useful for processors with a register stack.

The Santhanam reference proposes a two-pass compilation method for allocation of global variables. The two-pass compilation method involves a program analyzer and a persistent program database. Good run-time improvements are reported because the method allows a single callee-saved register to be used for different promoted global variables in disjoint regions of the call graph. However, the two-pass compilation poses a large compile-time overhead: aside from the execution time of the program analyzer (the compiler first phase), the compiler second phase has to query the program database and either read in the intermediate code files or re-process the source files.

Similar to the Santhanam reference, U.S. Pat. No. 7,069,549 to Robert J. Kushlis (the “Kushlis” reference) describes a method for register allocation over the entire application. Because a single interference graph is built for all variables from all functions in the application program, this method is only practical for application programs with a small number of functions due to memory and compile-time constraints. The Kushlis reference disclose a method, similar to the method of the Santhanam reference, that requires two passes over all functions in the application program. Transversals are performed in reverse order and in forward order over a linked list of all functions while maintaining three sets of virtual registers. Since the second set includes all the virtual registers associated with global variables, and these registers are unconditionally assigned on all executions of the function (see column 5, first paragraph of the Kushlis reference), the method of the Kushlis reference assumes that global variables are already allocated to registers.

The number of register stack engine (RSE) spills may be reduced in general by several approaches including multiple allocation optimizations (see A. Settle, D. Connors, G. Hoflehner, and D. Lavery, “Optimization for the Intel Itanium architecture register stack,” Proceedings of International Symposium on Code Generation and Optimization, 2003), interprocedural stacked register allocation (see L. Yang et al, “Inter-procedural stacked register allocation for Itanium like architecture,” Proceedings of ICS '03 Conference, 2003), or prematerialization (see the above-mentioned Baev reference). However, these methods do not attempt to directly reduce RSE spills specifically due to global variables.

The present application discloses a highly inventive solution that addresses both problems of reducing memory references and reducing stacked register usage for global variables. It is efficient one-pass solution which does not require a program database or separate summary files, and it does not incur large compile-time overhead.

Global registers are architecturally visible hardware registers that may be used to hold the values of global variables. In addition to traditional callee-saved (preserved) and caller-saved (scratch) registers, a processor with a register stack has stacked registers. However, stacked registers are saved and restored automatically by a call/return mechanism. Therefore, it is typically difficult and/or non-profitable to use a register stack for values of global variables.

A previous technique on a RISC processor used only a subset of callee-saved registers as global registers (see the Santhanam reference). However, in accordance with an embodiment of the invention, global registers include not only callee-saved registers, they also include a subset of scratch registers if an application has a large number of global variables. This embodiment may be particularly useful for target processors with a register stack, because such processors typically have a limited set of callee-saved registers (because a part of their registers are stacked).

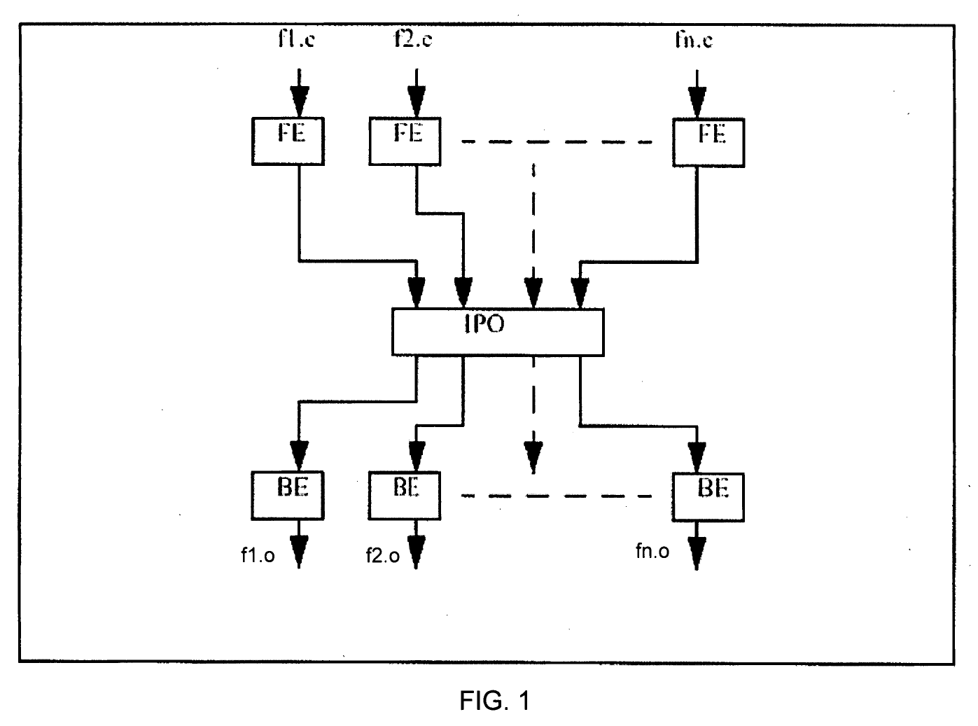

The present application discloses a novel and inventive method and apparatus for efficient interprocedural register allocation for global variables on processors with a register stack. The inventive method and apparatus may be implemented in general accordance with the interprocedural optimization compiler module described below in relation to FIG. 1.

FIG. 1 is a schematic diagram illustrating components of a cross-module compiler in accordance with an embodiment of the invention. As shown, the cross module compiler implements an interprocedural optimization compilation model which splits compilation of an application program into three phases: a front-end phase, an interprocedural analysis phase, and a back-end phase.

Front-end (FE) components perform the front-end phase, an interprocedural optimizer (IPO) performs the interprocedural analysis phase (IPA phase), and back-end (BE) components perform the back-end phase. While FE and BE components each operate on a single module/file at a time, the IPO operates on the whole application (entire set of modules and files) and computes interprocedural information. Communication between the FE components and the IPO, and between the IPO and the BE components, may be through interprocedural executable and linking format (IELF) files.

The front-end (FE) components of the compiler receives the source files (f1.c, f2.c, f3.c, . . . , fn.c) of the program. Each FE component receives an input program module or source file, and writes out an intermediate representation of the program module or source file. The outputs of the FE components are fed to the IPO.

Each FE component operates on a single module or file at a time and collects procedure-level summaries that are needed for interprocedural analysis. The summary for a given optimization is a minimal or near minimal subset of program representation that can determine the legality and profitability for the optimization. In accordance with an embodiment of the invention, for each procedure p, one of the FE components computes a summary Summary_p. The summary Summary_p includes the set of global variables referenced in the procedure, along with their reference count.

The IPO may also be called the cross-module optimizer (CMO). The IPO performs cross-file optimizations and writes out optimized intermediate representations for each source file in the user program. Unlike the FE and BE components, the IPO operates on the whole application (i.e. the entire set of modules and files) and computes interprocedural information.

The back-end (BE) modules receive the output of the IPO, perform low-level optimizations, and generate the object files (f1.o, f2.o, f3.o, . . . , fn.o). Each BE component operates on a single module or file at a time.

Because they operate on separate program modules or source files, the FE and the BE components may be executed in parallel at the module granularity to take advantage of multiple processors that may be available within a machine or across a pool of networked machines. However, the interprocedural analysis phase performed by the IPO is sequential in nature and thus typically becomes a major bottleneck in overall compilation time.

In accordance with an embodiment of the invention, in order to subsequently perform subsequent interprocedural register allocation of global variables, a Summary_p is computed for each procedure p by the FE components.

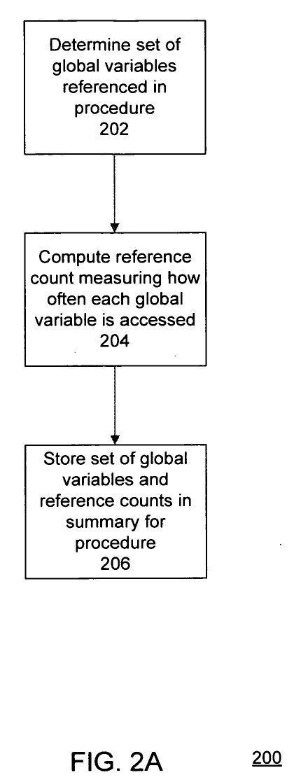

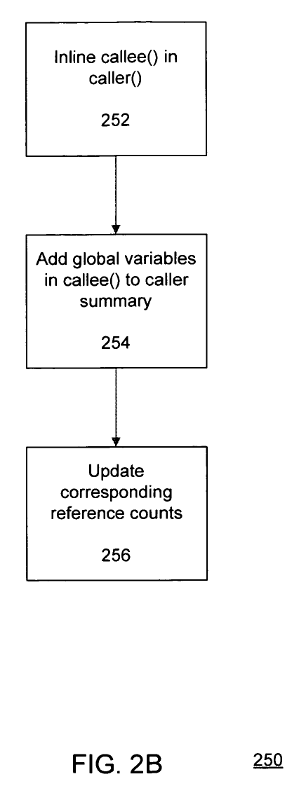

FIG. 2A depicts a method 200 performed by an FE component in generating said Summary_p for each procedure p in accordance with an embodiment of the invention. In a first block, the FE component determines 202 a set of global variables Set_p referenced in the procedure p. For example, Set_p={g1; g2; g3; . . . ; gk}. In addition, the FE component computes 204 a reference count for each global variable in the set. The reference count measures how often each global variable is accessed in the procedure p. Both the set of global variables Set_p and the reference counts per global variable are then stored 206 in a summary file Summary_p for the procedure p. For example, Summary_p={g1, c1; g2, c2; g3, c3; . . . ; gk, ck}, where c1, c2, c3, . . . , ck are the reference counts corresponding to the global variables g1, g2, g3, . . . , gk, respectively.

In accordance with one specific implementation, the reference counts may be estimated by dynamic profiling. Dynamic profiling estimates reference counts by running the application executable with inputs that represent real workloads. In another specific implementation, the reference counts may be estimated by static heuristics. Static heuristics estimate reference counts by considering the syntactic structure, usually loops, of the application. We assume that each loop iterates a curtain number of times.

Inlining transformations are a major part of any IPO infrastructure, so the interaction of interprocedural register allocation of global variables with inline transformations is now considered. FIG. 2B is a flow chart depicting a method 250 performed by the IPO of updating reference counts after each inlining transformation in accordance with an embodiment of the invention.

As shown, after every inline transformation 252 in the IPA phase, say after inlining a call to callee( ) in callerO, this method 250 adds 254 the global variables in callee( ) to caller( ) summary and updates 256 the corresponding reference counts. This method 250 is performed after each inline transformation.

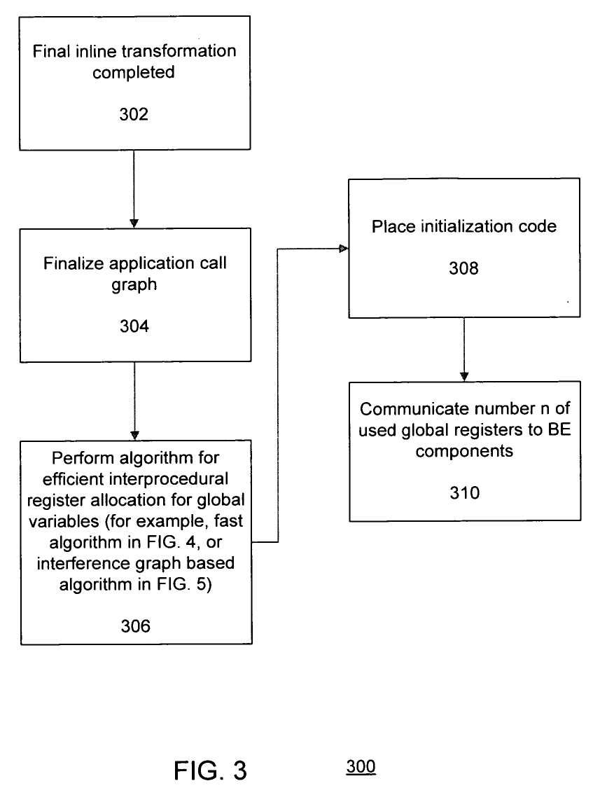

FIG. 3 is a flow chart depicting a method in which an algorithm for efficient interprocedural register allocation is performed by the IPO in accordance with an embodiment of the invention. After the final inline transformation is completed 302 (the steps shown in FIG. 2 have been performed for each inline transformation), the application call graph is kept or stored 304. Thereafter, an algorithm is performed 306 for the efficient interprocedural register allocation of global variables (i.e. the procedure for global variable promotion).

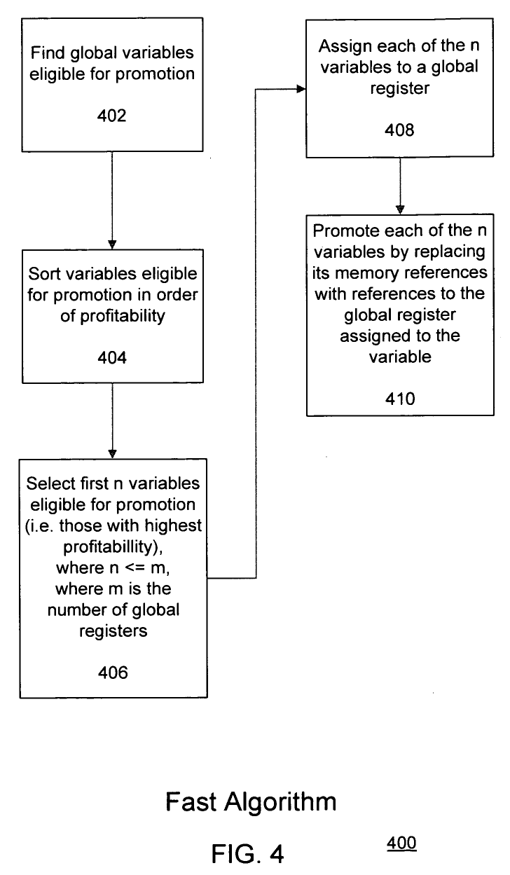

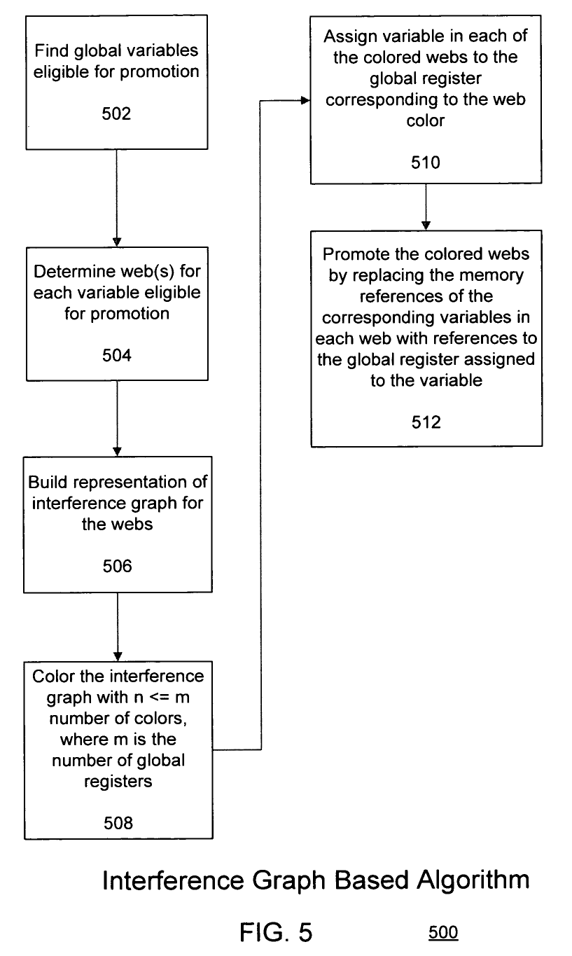

The algorithm performed 306 may be, for example, the fast algorithm 400 described in relation to FIG. 4, or the interference graph based algorithm 500 described below in relation to FIG. 5. In absence of inlining transformations during the IPA phase, the original call graph may be used, and the method may proceed more directly to the procedure for global variable promotion.

Thereafter, appropriate initialization code may be placed 308 for the promoted variables. For the fast algorithm 400, we add instructions at the application entry point (e.g. at the beginning of main ( ) procedure in C/C++ programs) to initialize global registers associated with the promoted variables. For the interference graph based algorithm 500, we insert load instructions at the entries of the promoted webs and store instructions at the exits of the promoted webs.

Note that the promotion of the global variables done in step 306 and the placement of the initialization code in step 308 may be performed in the IPA phase by the IPO by updating an intermediate representation for impacted procedures in the IELF files.

Finally, the number n of global registers used for the promoted global variables may be communicated 310 from the IPO to BE components. The BE components are then able to determine that the remaining un-assigned (m-n) global registers may be used for intraprocedural register allocation, where m is the number of global registers in the target processor.

Thereafter, the BE phase may continue with global per-procedure optimizations. Each BE component completes intraprocedural register allocation for the rest of live-ranges in the procedure.

Alternatively, instead of performing the global variable promotion in the IPA phase, as described above, the global variable promotion may be performed in the BE phase. In this alternate embodiment, a transformed summary with the promoted global variables and assigned global registers, e.g. TransformedSummary_p=(g1, r2, Init; g3, r3, nolnit), is written by the IPO to the IELF file containing procedure p. Here, each triple data element in the transformed summary consists of a promoted global variable (for example, g1 or g3), the assigned global register to the variable (for example, r2 or r3), and a Boolean indicating if an initialization of the variable is needed (i.e. Init or nolnit). The update of the intermediate representation (IR) for the procedure in order to implement global variable promotion may then be performed in BE phase.

FIG. 4 is a flow chart depicting a fast algorithm 400 performed by the IPO for efficient interprocedural register allocation of global variables in accordance with an embodiment of the invention. First, all the global variables in the application which are eligible for promotion are found or determined 402. These global variables eligible for promotion may be found using the summary files described above. Various criteria involving, for example, size of the variable and aliasing to other variables, may be used to determine those global variables eligible for promotion.

These global variables eligible for promotion may then be sorted 404 in order of profitability of such promotion. By profitability, we mean a quantitative measure of performance improvement that is estimated or expected if the particular global variable is promoted. After said sorting 404, the first variable may be the most profitable to promote, the second variable may be the second most profitable to promote, the third variable may be the third most profitable to promote, and so forth.

After the sorting, the first n global variables eligible for promotion (i.e. those n variables with the highest estimated profitability) are selected 406. Here, the number n is less than or equal to m, where m is the number of global registers in the target processor. As discussed above, global registers are architecturally visible hardware registers that may be used to hold the values of global variables.

Each of the n selected variables is then assigned 408 to one of the m global registers. In this fast algorithm 400, each global register may have a single global variable assigned to it.

Finally, each of the n selected variables may then be promoted 410 by replacing its memory references with references to the particular global register assigned to the variable.

FIG. 5 is a flow chart depicting an interference graph based algorithm 500 performed by the IPO for efficient interprocedural register allocation of global variables in accordance with another embodiment of the invention. First, similar to step 402 in FIG. 4, all the global variables in the application which are eligible for promotion are found or determined 502. These global variables eligible for promotion may be found using the summary files described above.

Next, instead of simply sorting 404 these variables per FIG. 4, this algorithm applies a more complex interference graph based process. In this process, “webs” are determined 504 for each global variable eligible for promotion. A web for a global variable is a minimal subgraph of the application call graph such that the global variable is neither referenced (locally) in an ancestor node nor a descendent node of the subgraph. In other words, no module calling any module in the web (i.e. no ancestor node) has a local reference to the variable, and no module called by any module in the web (i.e. no descendent node) has a local reference to the variable.

A representation of the interference graph for all webs for the variables from step 504 is then built 506, and the interference graph is then colored 508 with n “colors,” the number n being less than or equal to m, where the number m is the number of global registers in the target processor. Here, each “color” represents a global register in the target processor.

The global variable in each colored web is then assigned 510 to the global register corresponding to the color for that web. The colored webs are then promoted 512 by replacing the memory references of the corresponding variable in each web with references to the global register assigned to the variable in step 510.

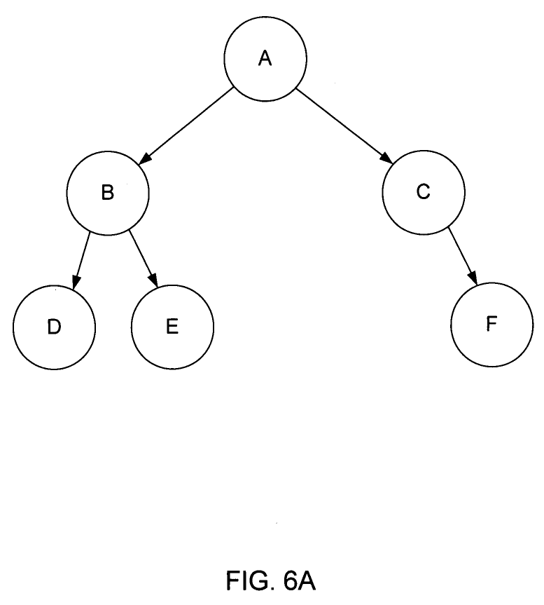

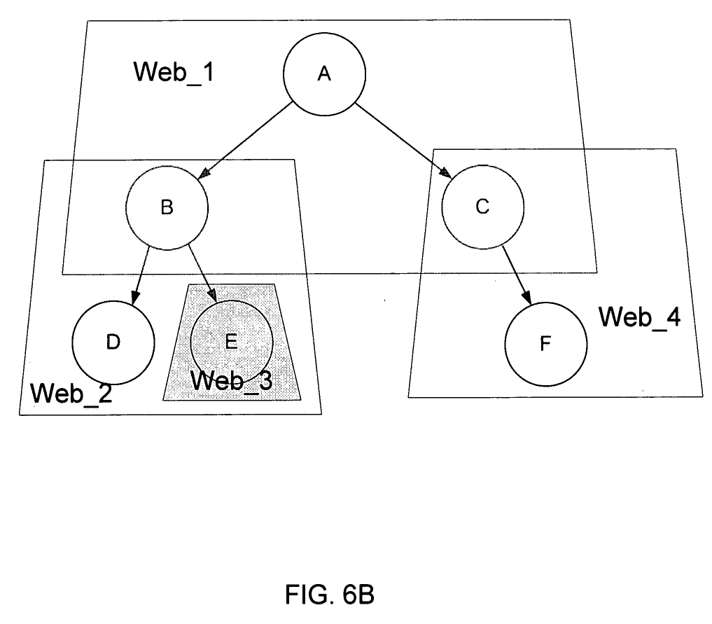

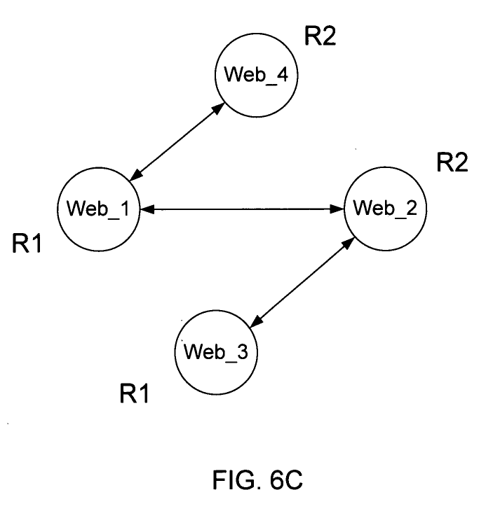

For explanatory purposes, a very simple example of an interference graph is now discussed in relation to FIGS. 6A through 6C. Further discussion of the use of an interference graph is given in the Santhanam reference.

FIG. 6A is a call graph showing procedures of an example software application being compiled and call sites between those procedures. The procedures are represented by the nodes labeled A, B, C, D, E and F. The call sites are represented by the arrows between the nodes. An arrow goes from the caller (the predeccessor procedure) to the callee (the successor procedure).

Table 1 below shows references to global variables eligible for promotion in the procedures of the example application.

TABLE 1
References to global variables eligible for promotion

| | | Successor | Predecessor |
|---|---|---|---|
| Procedure | Local References | References | References |
| A | g3 | g1, g2, g3 | None |
| B | g2, g3 | g1, g2 | g3 |
| C | g1, g3 | g1 | None |
| D | g2 | None | g2, g3 |
| E | g1, g2 | None | g2, g3 |
| F | g2 | None | g1, g3 |

In the above table, the global variables eligible for promotion are g1, g2 and g3. As shown in the Local References column, procedures C and E reference g1, procedures B, D, E and F reference g2, and procedures B and C reference g3.

The Successor References column shows the global variables referenced by a successor procedure. For example, procedures B and C are successors to procedure A, and procedures B and C have local references to g1, g2, and g3. Hence, procedure A is shown as having successor references g1, g2, and g3.

The Predecessor References column shows the global variables referenced by a predecessor procedure. For example, procedure B is a predecessor to procedure D. Procedure B has local references to g2 and g3. Hence, procedure D is shown as having predecessor references g2 and g3.

Table 2 below shows a table for assigning global registers to color webs based on interference between webs in accordance with an embodiment of the invention.

TABLE 2
Assigning global registers to color webs

| Color Web | Global Variable | Interfering Webs | Global Register |
|---|---|---|---|
| Web_1 | g3 | Web_2, Web_4 | R1 |
| Web_2 | g2 | Web_1, Web_3 | R2 |
| Web_3 | g1 | Web_2 | R1 |
| Web_4 | g2 | Web_1 | R2 |

FIG. 6B shows color webs laid over the call graph of the example software application. As mentioned above, a color web for a global variable is a minimal subgraph of the application call graph such that the global variable is neither referenced in an ancestor node nor a descendent node of the subgraph.

Here, Web_1 is associated with global variable g3 which is referred to locally in procedures A, B, and C, but not in descendent procedures D, E and F. Web_2 is associated with global variable g2 which is referred to locally in procedures B, D and E, but not in ancestor procedure A. Web_3 is associated with global variable g1 which is referred to locally in procedure E, but not in ancestor procedure B. Finally, Web_4 is associated with global variable g2 which is referred to locally in procedure F, but not in ancestor procedure C.

FIG. 6C depicts an interference graph derived from FIG. 6B. As seen in FIG. 6B, Web_1 interferes (i.e. overlaps or shares a common call graph node) with Web_2 and Web_4. This is shown in FIG. 6C by the arrows from Web_1 to Web_2 and Web_4. Similarly, Web_2 interferes with Web_1 and Web_3, which is shown by the arrows from Web_2 to Web_1 and Web_3. Web_3 interferes with Web_2, which is shown by the arrows from Web_3 to Web_2. Finally, Web_4 interferes with Web_1, which is shown by the arrows from Web_4 to Web_1.

Interfering color webs cannot be promoted to the same global register. In this example, Web_1 and Web_3 do not interfere and so may be promoted to a first global register R1, and Web_2 and Web_4 do not interfere and so may be promoted to a second global register R2. Advantageously, in this way, two global registers are used to promote three global variables.

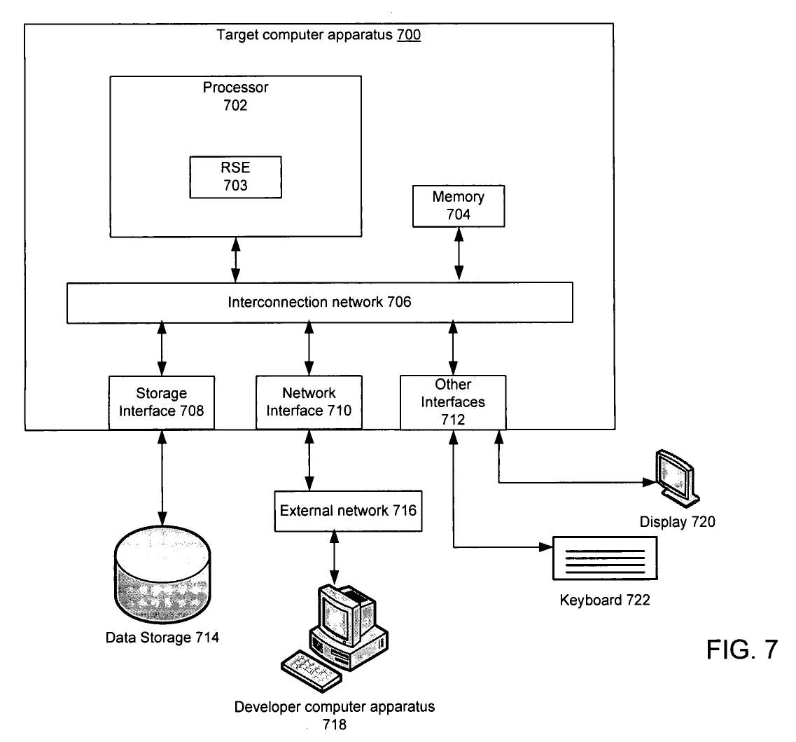

FIG. 7 is a schematic diagram depicting an example computer apparatus 700 which may be configured to perform the methods in accordance with an embodiment of the invention. Other designs for the computer apparatus may be used in alternate embodiments.

As shown in FIG. 7, the computer apparatus 700 comprises a processor 702, a computer-readable memory system 704, a storage interface 708, a network interface 710, and other interfaces 712. These system components are interconnected through the use of an interconnection network (such as a system bus or other interconnection system) 706. In one particular embodiment, the processor 702 comprises an Itanium™ type processor with register stack engine (RSE) 703, which is commercially available from Intel Corporation of Santa Clara, Calif.

The storage interface 708 may be used to connect storage devices 714 to the computer apparatus 700. The network interface 710 may be used to communicate with other computers 718 by way of an external network 716. The other interfaces may interface to various devices, for example, a display 720, a keyboard 722, and other devices.

Applicants have implemented an embodiment of the above-disclosed technique for efficient interprocedural register allocation for global variables for use with a large commercial database application. Advantageously, a notable improvement in performance of about 1.2%. This is a respectable improvement in performance for a large and complex application.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined by the following claims, which are to be construed in accordance with established doctrines of claim interpretation.

What is claimed is:

1. A method of compiling a computer program with interprocedural register allocation for global variables, the method comprising:
performing a front-end phase which receives source files for the computer program, processes the source files individually, and outputs intermediate representations of the files, wherein there is one intermediate representation corresponding to each said source file;
performing an interprocedural analysis phase which receives the intermediate representations from the front-end phase, processes the intermediate representations together to compute interprocedural information and selecting eligible global variables for promotion, and outputs optimized intermediate representations, wherein there is one optimized intermediate representation corresponding to each said source file; and
performing a back-end phase which receives the optimized intermediate representations from the interprocedural analysis phase, processes the optimized intermediate representations individually, and outputs object files, wherein there is one object file corresponding to each said source file,
wherein promotion of the selected eligible global variables comprises replacing memory references to the selected eligible global variables with references to global registers assigned to said variables.

2. The method of claim 1, wherein said promotion of the selected eligible global variables is performed in the interprocedural analysis phase.

3. The method of claim 1, wherein said promotion of the selected eligible global variables is performed in the back-end phase using a transformed summary for each module of the computer program written in the interprocedural analysis phase.

4. The method of claim 1 further comprising, during the interprocedural analysis phase:
computing a profitability for promoting each eligible global variable.

5. The method of claim 4 further comprising, during the interprocedural analysis phase:
sorting the eligible global variables in order of profitability; and
selecting a set of most profitable variables as the selected eligible global variables for promotion.

6. The method of claim 1 further comprising, during the interprocedural analysis phase:
determining at least one web for each global variable eligible for promotion, wherein a web is defined as a minimal subgraph of a call graph for the computer program such that the global variable is neither referenced in an ancestor node or a descendent node of the subgraph.

7. The method of claim 6 further comprising, during the interprocedural analysis phase:
building an interference graph of the webs;
coloring the interference graph with a number of colors which is less than or equal to a number of the global registers.

8. The method of claim 7, wherein more than one global variable is promoted to a single global register using the interference graph.

9. The method of claim 8 further comprising, after said promotion of the selected eligible global variables:
placing initialization code at entries and exits of the webs of said promoted variables.

10. The method of claim 1 further comprising, after said promotion of the selected eligible global variables:
communicating a number of used global registers so that a number of remaining unassigned global registers are determinable during the back-end phase.

11. A method of compiling a computer program in a single pass with interprocedural register allocation for global variables, the method comprising:
performing an interprocedural analysis phase which receives the intermediate representations from a front-end phase which receives source files, processes the intermediate representations together to perform inlining and to select eligible global variables for promotion, and outputs optimized intermediate representations to a back-end phase which outputs object files,
wherein promotion of the selected eligible global variables comprises replacing memory references to the selected eligible global variables with references to global registers assigned to said variables.

12. The method of claim 11, wherein said promotion of the selected eligible global variables is performed in the interprocedural analysis phase.

13. The method of claim 11, wherein said promotion of the selected eligible global variables is performed in the back-end phase using a transformed summary for each module of the computer program written in the interprocedural analysis phase.

14. The method of claim 11, further comprising, during the front-end phase, for each procedure of the computer program:
determining a set of global variables referenced; and
computing a reference count measuring how many times each global variable is accessed.

15. The method of claim 14, further comprising, during the interprocedural analysis phase, after inlining a call to a callee procedure in a caller procedure:
adding global variables in the callee procedure to the set of global variables referenced in the caller procedure; and
updating reference counts in the caller procedure.

16. The method of claim 11 further comprising, during the interprocedural analysis phase:
computing a profitability for promoting each eligible global variable.

17. The method of claim 16 further comprising, during the interprocedural analysis phase:
sorting the eligible global variables in order of profitability; and
selecting a set of most profitable variables as said selected eligible global variables to be promoted.

18. The method of claim 11 further comprising, during the interprocedural analysis phase:
determining at least one web for each global variable eligible for promotion, wherein a web is defined as a minimal subgraph of a call graph for the computer program such that the global variable is neither referenced in an ancestor node or a descendent node of the subgraph.

19. The method of claim 18 further comprising, during the interprocedural analysis phase:
building an interference graph of the webs;
coloring the interference graph with a number of colors which is less than or equal to a number of the global registers.

20. The method of claim 19, wherein more than one global variable are promoted to a single global register using the interference graph.

21. The method of claim 20 further comprising:
placing initialization code at entries and exits of the webs of said promoted variables.

22. The method of claim 11 further comprising:
communicating a number of used global registers so that a number of remaining unassigned global registers are determinable during the back-end phase.

23. A computer-readable medium configured with computer-readable instructions for compiling a computer program with interprocedural register allocation for global variables, the computer-readable medium comprising:
computer-readable instructions stored on said medium which are configured to perform a front-end phase which receives source files for the computer program, processes the source files individually, and outputs intermediate representations of the files, wherein there is one intermediate representation corresponding to each said source file;
computer-readable instructions stored on said medium which are configured to perform an interprocedural analysis phase which receives the intermediate representations from the front-end phase, processes the intermediate representations together to compute interprocedural information and selecting eligible global variables for promotion, and outputs optimized intermediate representations, wherein there is one optimized intermediate representation corresponding to each said source file; and
computer-readable instructions stored on said medium which are configured to perform a back-end phase which receives the optimized intermediate representations from the interprocedural analysis phase, processes the optimized intermediate representations individually, and outputs object files, wherein there is one object file corresponding to each said source file,
wherein promotion of the selected eligible global variables comprises replacing memory references to the selected eligible global variables with references to global registers assigned to said variables.

24. A computer-readable medium configured with computer-readable instructions for compiling a computer program with interprocedural register allocation for global variables, the computer-readable medium comprising:
computer-readable instructions stored on said medium which are configured to perform an interprocedural analysis phase which receives the intermediate representations from a front-end phase which receives source files, processes the intermediate representations together to perform inlining and to select eligible global variables for promotion, and outputs optimized intermediate representations to a back-end phase which outputs object files,
wherein promotion of the selected eligible global variables comprises replacing memory references to the selected eligible global variables with references to global registers assigned to said variables.
